(19) United States
(12) Patent Application Publication
(10) Pub. No.: US 2026/0296849 A1
(43) Pub. Date: Oct. 1, 2026

(54) COUNTERWEIGHT ASSEMBLY FOR A LIFTING MACHINE

(71) Applicant: Caterpillar Inc., Peoria, IL (US)

(72) Inventor: Jason J. Forck, Chillicothe, IL (US)

(73) Assignee: Caterpillar Inc., Peoria, IL (US)

(21) Appl. No.: 19/093,672

(22) Filed: Mar. 28, 2025

(51) Int. Cl. B66C 23/76; B66C 23/44; F16L 1/06

(52) U.S. Cl. CPC B66C 23/76; B66C 23/44; F16L 1/065

(57) ABSTRACT

A counterweight assembly may include a machine mounting bracket arranged on an axis that is substantially vertical, a first elongated linkage element pivotally coupled to the machine mounting bracket at a first end of the first elongated linkage element and pivotally coupled to a plate mounting bracket at a second end of the first elongated linkage element, a second elongated linkage element pivotally coupled to the plate mounting bracket at an end of the second elongated linkage element, and an actuator cylinder coupled to the second elongated linkage element. Extension of the actuator cylinder is to cause the first elongated linkage element and the second elongated linkage element to swing away from the axis in a direction. The first elongated linkage element, the second elongated linkage element, and the actuator cylinder are in-line within a plane defined by the axis and the direction.

### TECHNICAL FIELD

The present disclosure relates generally to lifting machines and, for example, to a counterweight assembly for a lifting machine.

### BACKGROUND

A pipelayer is a machine that is used for installing large, heavy pipeline segments into the earth and/or above ground. During operation, the pipelayer machine extends the weight of the segment laterally away from the chassis, engine, and undercarriage of the pipelayer machine (e.g., with the weight being cantilevered out over surrounding terrain). Depending on the weight of the segment being lifted and the length of the boom, the pipelayer machine may be subject to potential tipping and instability. Counterweights, which are positioned on an opposite side of the pipelayer machine from the boom, counteract the weight of the segment being lifted to increase lifting capacity and resist tipping. The counterweights may be installed on an assembly that can be extended outwards from the pipelayer machine to shift a center of gravity of the counterweights. Generally, the assembly may include a complex system of linkages and actuators that are difficult to machine, assemble, and install on the pipelayer machine.

The counterweight assembly of the present disclosure solves one or more of the problems set forth above and/or other problems in the art.

### SUMMARY

A counterweight assembly may include a machine mounting bracket arranged on an axis that is substantially vertical, a first elongated linkage element pivotally coupled to the machine mounting bracket at a first end of the first elongated linkage element and pivotally coupled to a plate mounting bracket at a second end of the first elongated linkage element, a second elongated linkage element pivotally coupled to the plate mounting bracket at an end of the second elongated linkage element, and an actuator cylinder coupled to the second elongated linkage element. Extension of the actuator cylinder is to cause the first elongated linkage element and the second elongated linkage element to swing away from the axis in a direction. The first elongated linkage element, the second elongated linkage element, and the actuator cylinder are in-line within a plane defined by the axis and the direction.

A counterweight may include a weight assembly including a carrying plate configured to carry one or more weights, a plate mounting bracket, a machine mounting bracket, a first elongated linkage element pivotally coupled to the machine mounting bracket, a second elongated linkage element, and an actuator cylinder. The plate mounting bracket is connected to the carrying plate. The plate mounting bracket includes a pair of opposing bracket plates that define a linkage region between the pair of opposing bracket plates. The first elongated linkage element is pivotally coupled to the plate mounting bracket within the linkage region. The second elongated linkage element is pivotally coupled to the plate mounting bracket within the linkage region. The actuator cylinder is coupled to the second elongated linkage element in alignment with the linkage region.

A lifting machine includes a chassis having a front end and a rear end defining a machine axis, a crane assembly mounted on the chassis, and a counterweight assembly. The counterweight assembly includes a machine mounting bracket mounted on the chassis, a first elongated linkage element pivotally coupled to the machine mounting bracket at a first end of the first elongated linkage element and pivotally coupled to a plate mounting bracket at a second end of the first elongated linkage element, a second elongated linkage element pivotally coupled to the plate mounting bracket at an end of the second elongated linkage element, and an actuator cylinder coupled to the second elongated linkage element. The first elongated linkage element, the second elongated linkage element, and the actuator cylinder are in-line within a transverse plane to the machine axis.

### BRIEF DESCRIPTION OF THE DRAWINGS

FIG. 1 is a front view of an example lifting machine.

FIG. 2 is an exploded view of an example counterweight assembly.

FIG. 3 is a perspective view of the counterweight assembly of FIG. 2.

FIG. 4 is a side view of the counterweight assembly of FIG. 2.

FIG. 5 is a front view of the counterweight assembly of FIG. 2.

### DETAILED DESCRIPTION

This disclosure relates to a counterweight assembly, which is applicable to any machine that performs a lifting operation associated with an industry such as, for example, mining, construction, farming, transportation, or another industry.

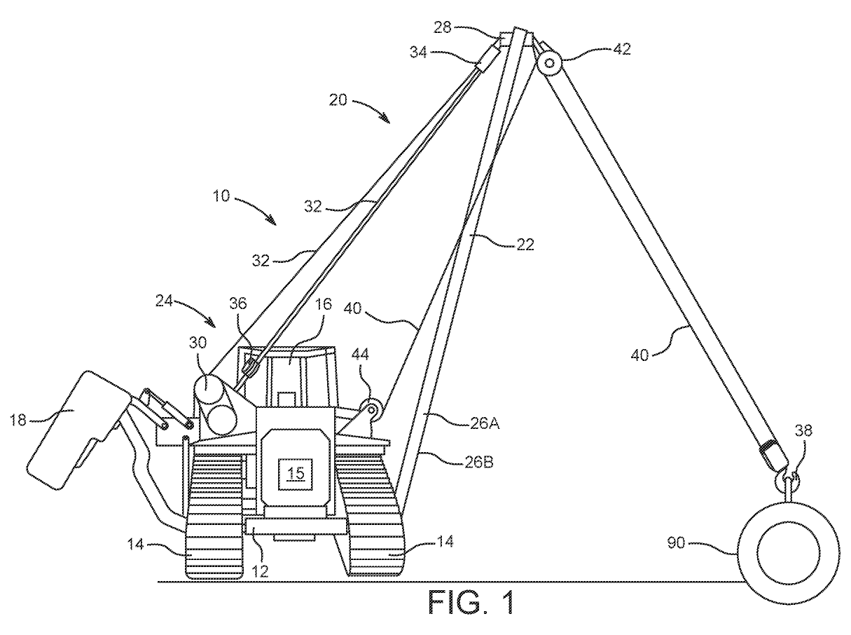

FIG. 1 is a front view of an example lifting machine 10 described herein. As an example, the lifting machine 10 may be a pipelayer machine, as shown. However, in other examples, the lifting machine 10 may be another type of machine, such as a crane or an earthmoving machine (e.g., an excavator).

The lifting machine 10 includes a chassis 12, a pair of drive tracks 14 to engage with a ground surface, a power source 15 (e.g., an internal combustion engine), an operator cab 16, a counterweight assembly 18 mounted on the chassis 12, and a crane assembly 20 mounted on the chassis 12 opposite the counterweight assembly 18. The chassis 12 defines a machine axis from a front end to a rear end of the chassis 12 (e.g., into the plane of the page) that defines a direction of travel of the lifting machine 10.

The crane assembly 20 includes a boom 22 and a winch system 24 configured to drive lifting operations of the lifting machine 10. The boom 22 includes a pair of legs (e.g., front leg 26A and rear leg 26B) that, at a proximal end, may be spaced apart and independently hinged to the chassis 12. The legs 26A-B extend away from the chassis 12 and are joined together at boom tip 28. The winch system 24 includes a winch 30 and a first set of lifting cables 32 extending from the winch 30. The first lifting cables 32 are coupled to a series of pulleys, or sheaves (e.g., first pulley 34 and second pulley 36), to raise and lower the boom 22.

The winch system 24 includes a terminating connector (e.g., grapple hook 38) to couple the crane assembly 20 to the object (e.g., pipe 90) being lifted. The winch system 24 includes a second set of lifting cables 40 extending from the winch 30. The second lifting cables 40 are coupled to a series of pulleys, or sheaves (e.g., third pulley 42 and fourth pulley 44), to raise and lower the grapple hook 38.

As indicated above, FIG. 1 is provided as an example. Other examples may differ from what is described in connection with FIG. 1.

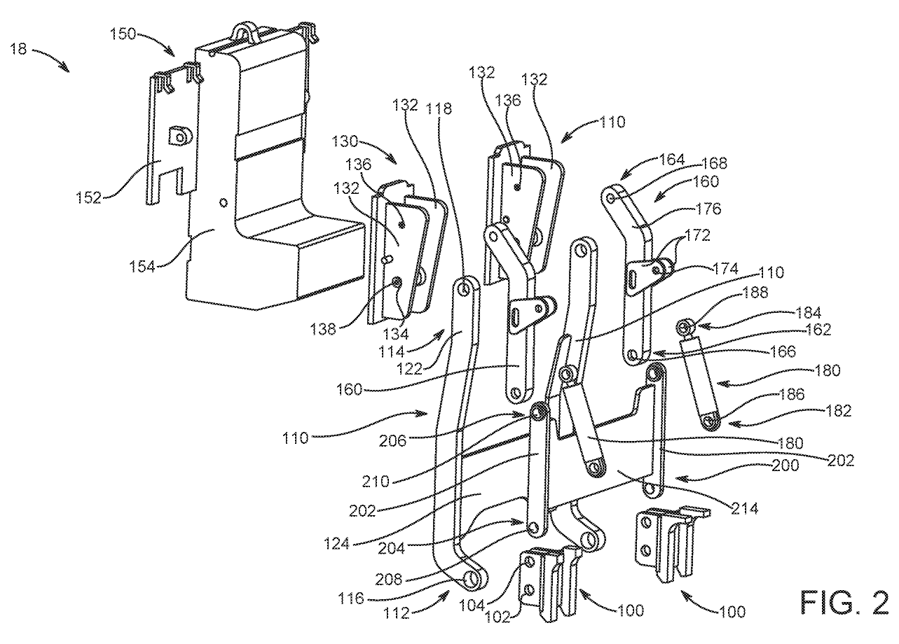

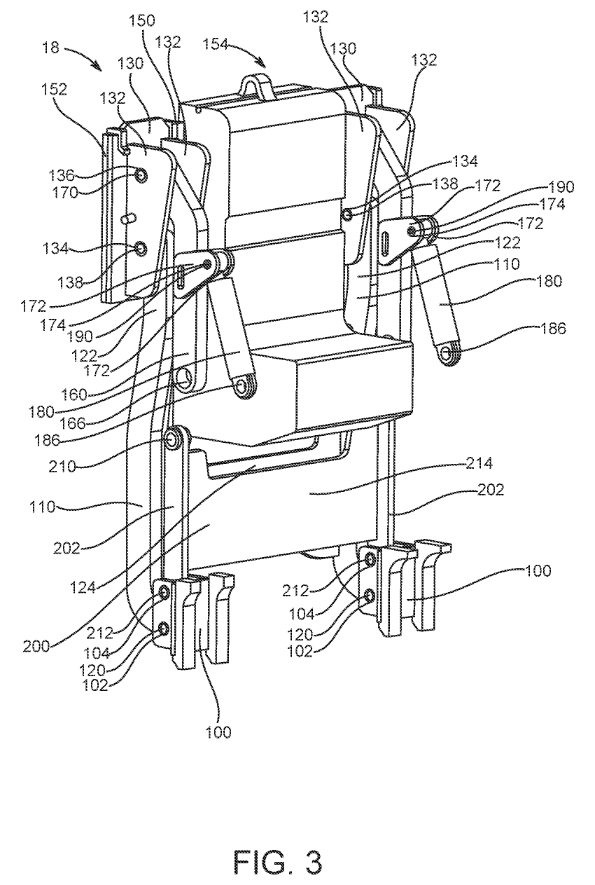

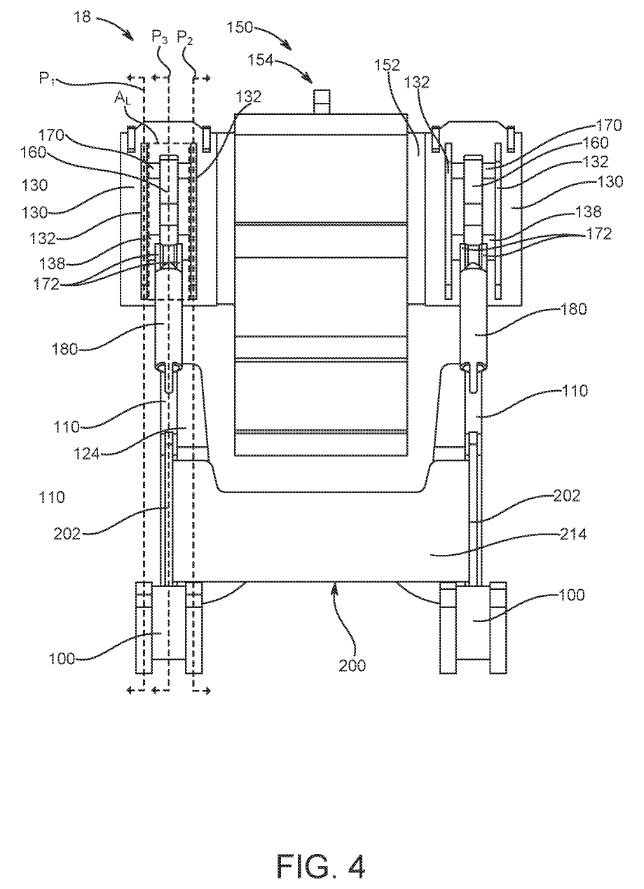

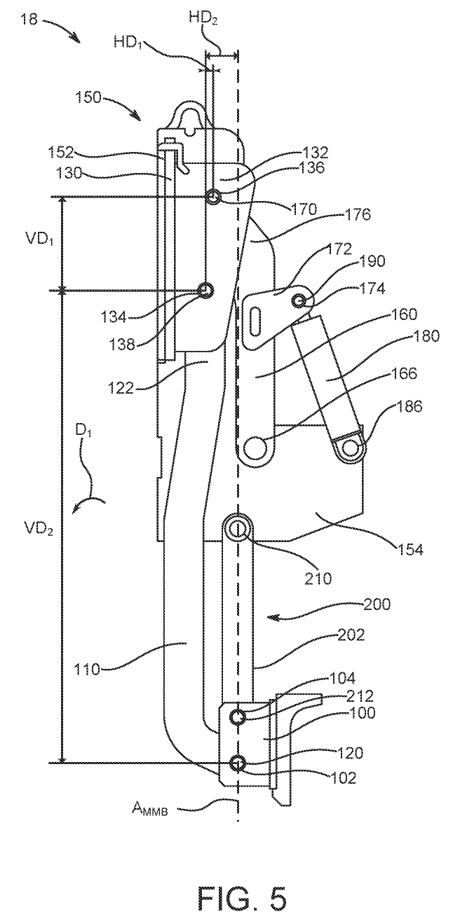

FIGS. 2-5 show an example of the counterweight assembly 18. In particular, FIG. 2 is an exploded view of the counterweight assembly 18, FIG. 3 is a perspective view of the counterweight assembly 18, FIG. 4 is a side view of the counterweight assembly 18, and FIG. 5 is a front view of the counterweight assembly 18.

The counterweight assembly 18 is configured to be adjusted between a retracted configuration and an extended configuration. When adjusting from the retracted configuration to the extended configuration, a center of gravity of the counterweight assembly 18 moves in a direction away from the boom 22 of the crane assembly 20 such that the counterweight assembly 18 may compensate for the weight of the pipe 90 coupled to the crane assembly 20 to prevent the lifting machine 10 from tipping over towards the pipe 90 due to the weight of the pipe 90. When adjusting from the extended configuration to the retracted configuration, the center of gravity of the counterweight assembly 18 moves in a direction towards the boom 22 of the crane assembly 20 to prevent the lifting machine 10 from tipping over towards the counterweight assembly 18 when the crane assembly 20 is not lifting the pipe 90.

The counterweight assembly 18 includes a pair of machine mounting brackets 100 mounted on (e.g., coupled to, etc.) the chassis 12. The machine mounting brackets 100 may be configured to couple to the chassis 12 proximate one of the drive tracks 14. For example, a first of the machine mounting brackets 100 may be configured to couple to a first portion of the chassis 12 positioned within one of the drive tracks 14 and a second of the machine mounting brackets 100 may be configured to couple to a second portion of the chassis 12 positioned within the same one of the drive tracks 14 (e.g., the drive track 14 surrounds the connection points of the machine mounting brackets 100 to the chassis 12). In other examples, the counterweight assembly 18 includes a single machine mounting bracket 100.

The machine mounting brackets 100 each define a lower machine mounting bracket aperture 102 extending through the machine mounting brackets 100 and an upper machine mounting bracket aperture 104 extending through the machine mounting brackets 100. The upper machine mounting bracket aperture 104 is positioned above the lower machine mounting bracket aperture 102 (e.g., relative to an orientation of the counterweight assembly 18 on the machine 10).

The counterweight assembly 18 includes a pair of first elongated linkage elements 110. The first elongated linkage elements 110 each have a first end 112 and an opposing second end 114. Each of the first elongated linkage elements 110 are pivotally coupled to one of the machine mounting brackets 100 at first connection points (e.g., first pivot points). For example, a first of the first elongated linkage elements 110 may be pivotally coupled to a first of the machine mounting brackets 100 and a second of the first elongated linkage elements 110 may be pivotally coupled to a second of the machine mounting brackets 100. The first elongated linkage elements 110 are pivotally coupled to the machine mounting brackets 100 at the first ends 112 of the first elongated linkage elements 110. In other examples, the counterweight assembly 18 includes a single first elongated linkage element 110.

The first elongated linkage elements 110 each define a lower first elongated linkage aperture 116 extending through the first elongated linkage elements 110 proximate the first ends 112 of the first elongated linkage elements 110 and an upper first elongated linkage aperture 118 extending through the first elongated linkage elements 110 proximate the second ends 114 of the first elongated linkage elements 110. Each of the first elongated linkage elements 110 are pivotally coupled to one of the machine mounting brackets 100 by a first fastener 120 (e.g., a pin, a bolt, a shaft, etc.) extending through the lower first elongated linkage aperture 116 of the first elongated linkage element 110 and the lower machine mounting bracket aperture 102 of the machine mounting bracket 100.

The first elongated linkage elements 110 each have a bent section 122. The bent sections 122 may bend inwards toward the machine mounting brackets 100 when the counterweight assembly 18 is in the retracted configuration.

In some examples, the counterweight assembly 18 includes a first cross plate 124 coupled between the first elongated linkage elements 110. For example, the first cross plate 124 may extend between the first elongated linkage elements 110 to ensure that the first elongated linkage elements 110 pivot together relative to the machine mounting brackets 100.

The counterweight assembly 18 includes a pair of plate mounting brackets 130. Each of the plate mounting brackets 130 is pivotally coupled to one of the first elongated linkage elements 110 at second connection points (e.g., second pivot points). Each of the plate mounting brackets 130 includes a pair of opposing bracket plates 132. Each of the bracket plates 132 defines a first bracket plate aperture 134 extending through the bracket plates 132 and a second bracket plate aperture 136 extending through the bracket plates 132. In other examples, the counterweight assembly 18 includes a single plate mounting bracket 130.

Each of the first elongated linkage elements 110 are pivotally coupled to one of the plate mounting brackets 130 at the second ends 114 of the first elongated linkage elements 110. For example, a first of the first elongated linkage elements 110 may be pivotally coupled to a first of the plate mounting brackets 130 and a second of the first elongated linkage elements 110 may be pivotally coupled to a second of the plate mounting brackets 130. Each of the first elongated linkage elements 110 are pivotally coupled to one of the plate mounting brackets 130 by a second fastener 138 (e.g., a pin, a bolt, a shaft, etc.) extending through the upper first elongated linkage aperture 118 of the first elongated linkage element 110 and the first bracket plate apertures 134 of the bracket plates 132 of the plate mounting bracket 130.

The counterweight assembly 18 includes a weight assembly 150. The weight assembly 150 includes a carrying plate 152 configured to carry one or more weights 154. The weights 154 may be configured to offset the weight of the pipe 90 lifted by the crane assembly 20 when the counterweight assembly 18 is in the extended configuration. The carrying plate 152 is connected to the plate mounting brackets 130. For example, the carrying plate 152 may include clips configured to engage the plate mounting brackets 130 to couple the carrying plate 152 to the plate mounting brackets 130. In some examples, the weights 154 are connected to the carrying plate 152 between the plate mounting brackets 130. For example, one of the plate mounting brackets 130 may be coupled to a first end of the carrying plate 152, an additional of the plate mounting brackets 130 may be coupled to an opposing second end of the carrying plate 152, and the weights 154 may be coupled to the carrying plate 152 at a location along a length of the carrying plate 152 that is between the first end of the carrying plate 152 and the second end of the carrying plate 152.

The counterweight assembly 18 includes a pair of second elongated linkage elements 160. The second elongated linkage elements 160 each have a first end 162 and an opposing second end 164. The second elongated linkage elements 160 are configured to pivotally couple to at least one of the chassis 12 or the winch system 24 at third connection points (e.g., third pivot points). The second elongated linkage elements 160 pivotally couple to the chassis 12 and/or the winch system 24 at the first ends 162 of the second elongated linkage elements 160. Each of the second elongated linkage elements 160 are in-line with one of the first elongated linkage elements 110. The second elongated linkage elements 160 being in-line with the first elongated linkage elements 110 may reduce a width of the plate mounting brackets 130 compared to if the second elongated linkage elements 160 were not in-line with the first elongated linkage elements 110. In other examples, the counterweight assembly 18 includes a single second elongated linkage element 160.

The second elongated linkage elements 160 each define a lower second elongated linkage aperture 166 extending through the second elongated linkage elements 160 proximate the first ends 162 of the second elongated linkage elements 160 and an upper second elongated linkage aperture 168 extending through the second elongated linkage elements 160 proximate the second ends 164 of the second elongated linkage elements 160. Each of the second elongated linkage elements 160 are configured to be pivotally coupled to the chassis 12 and/or the winch system 24 by a fastener extending through the lower second elongated linkage aperture 166 of the second elongated linkage element 160 and an aperture of the chassis 12 and/or the winch system 24.

The second elongated linkage elements 160 are each pivotally coupled to the plate mounting brackets 130 at fourth connection points (e.g., fourth pivot points). For example, a first of the second elongated linkage elements 160 may be pivotally coupled to a first of the plate mounting brackets 130 and a second of the second elongated linkage elements 160 may be pivotally coupled to a second of the plate mounting brackets 130. The second elongated linkage elements 160 are pivotally coupled to the plate mounting brackets 130 at the second ends 164 of the second elongated linkage elements 160. Each of the second elongated linkage elements 160 are pivotally coupled to one of the plate mounting brackets 130 by a third fastener 170 extending through the upper second elongated linkage aperture 168 of the second elongated linkage element 160 and the second bracket plate apertures 136 of the bracket plates 132 of the plate mounting bracket 130.

In some examples, when the counterweight assembly 18 is in the retracted configuration, the second connection points of the first elongated linkage elements 110 to the plate mounting brackets 130 is nearer (e.g., in a vertical direction) to the machine mounting brackets 100 than the fourth connection points of the second elongated linkage elements 160 to the plate mounting brackets 130. For example, when the counterweight assembly 18 is in the retracted configuration, the second fasteners 138 may be nearer to the machine mounting brackets 100 than the third fasteners 170.

The second elongated linkage elements 160 each include a pair of opposing actuator plates 172. Each of the actuator plates 172 defines an actuator plate aperture 174 extending through the actuator plates 172. In other examples, the second elongated linkage elements 160 each include a single actuator plate 172.

The second elongated linkage elements 160 each have a corresponding bent section 176 that corresponds to the bent section 122 of the machine mounting brackets 100. The bent sections 176 may bend outwards away from the machine mounting brackets 100 when the counterweight assembly 18 is in the retracted configuration. The bent sections 122 of the first elongated linkage elements 110 are configured to nest within the corresponding bent section 176 of a corresponding second elongated linkage element 160 when the counterweight assembly 18 is in the retracted configuration. For example, the bent sections 176 may be positioned above the bent sections 122 when the counterweight assembly 18 is in the retracted configuration. As another example, the second elongated linkage elements 160, including the bent sections 176, may surround a top side of the bent sections 122 of the first elongated linkage elements 110 and an internal side of the bent sections 122 of the first elongated linkage elements when the counterweight assembly 18 is in the retracted configuration. By nesting the bent sections 122 within the corresponding bent sections 176 when the counterweight assembly 18 is in the retracted configuration a footprint of the counterweight assembly 18 may be reduced to limit the space taken up by the lifting machine 10 and/or an extension distance of the counterweight assembly 18 from the operator cab 16 may be reduced to limit contact between the lifting machine 10 and objects surrounding the lifting machine 10.

The counterweight assembly 18 includes a pair of actuator cylinders 180. The actuator cylinders 180 are each extendable and retractable between a retracted orientation and an extended orientation to adjust the counterweight assembly 18 between the retracted configuration and the extended configuration. For example, the extension of the actuator cylinders 180 may cause the counterweight assembly 18 to move away from the retracted configuration and towards the extended configuration. As another example, the retraction of the actuator cylinders 180 may cause the counterweight assembly 18 to move away from the extended configuration and towards the retracted configuration. Each of the actuator cylinders 180 are in-line with one of the first elongated linkage elements 110 and/or one of the second elongated linkage elements 160. The actuator cylinders 180 being in-line with the first elongated linkage elements 110 and/or the second elongated linkage elements 160 may reduce horizontal loading of the counterweight assembly 18 compared to if the actuator cylinders 180 were not in-line with the first elongated linkage elements 110 and/or the second elongated linkage elements 160. In other examples, the counterweight assembly 18 includes a single actuator cylinder 180.

The actuator cylinders 180 each have a first end 182 and an opposing second end 184. The second ends 184 of the actuator cylinders 180 move away from the first ends 182 of the actuator cylinders 180 during the extension of the actuator cylinders 180 and move toward the first ends 182 of the actuator cylinders 180 during the retraction of the actuator cylinders 180. The actuator cylinders 180 are configured to pivotally couple to at least one of the chassis 12 or the winch system 24 at fifth connection points. The actuator cylinders 180 are configured to couple to the chassis 12 and/or the winch system 24 at the first ends 182 of the actuator cylinders 180. The actuator cylinders 180 are each pivotally coupled to one of the second elongated linkage elements 160 at sixth connection points. For example, a first of the actuator cylinders 180 may be pivotally coupled to a first of the second elongated linkage elements 160 and a second of the actuator cylinders 180 may be pivotally coupled to a second of the second elongated linkage elements 160. The actuator cylinders 180 are pivotally coupled to the second elongated linkage elements 160 at the second ends 184 of the actuator cylinders 180.

The actuator cylinders 180 each define a first actuator aperture 186 extending through the actuator cylinders 180 proximate the first ends 182 of the actuator cylinders 180 and a second actuator aperture 188 extending through the actuator cylinders 180 proximate the second ends 184 of the actuator cylinders 180. Each of the actuator cylinders 180 are configured to be pivotally coupled to the chassis 12 and/or the winch system 24 by a fastener extending through the lower second elongated linkage aperture 166 of the second elongated linkage element 160 and an aperture of the chassis 12 and/or the winch system 24. Each of the actuator cylinders 180 are pivotally coupled to one of the second elongated linkage elements 160 by a fourth fastener 190 extending through the second actuator aperture 188 of the actuator cylinder 180 and the actuator plate aperture 174 of the actuator plates 172 of the second elongated linkage element 160.

The counterweight assembly 18 includes a winch support 200. The winch support 200 transfers a portion of the weight of the counterweight assembly 18 from a first portion of the chassis 12 where the first elongated linkage elements 110 are coupled to the chassis 12 to a second portion of the chassis 12 and/or the winch system 24 to distribute the weight of the counterweight assembly 18. The winch support 200 includes a pair of support linkage elements 202. The support linkage elements 202 each have a first end 204 and an opposing second end 206. Each of the support linkage elements 202 are pivotally coupled to one of the machine mounting brackets 100 at seventh connection points (e.g., fifth pivot points). For example, a first of the support linkage elements 202 may be pivotally coupled to a first of the machine mounting brackets 100 and a second of the support linkage elements 202 may be pivotally coupled to a second of the machine mounting brackets 100. The support linkage elements 202 are pivotally coupled to the machine mounting brackets 100 at the first ends 204 of the support linkage elements 202. The support linkage elements 202 are each configured to pivotally couple to at least one of the chassis 12 or the winch system 24 at eighth connection points. The support linkage elements 202 are configured to pivotally couple to the chassis 12 and/or the winch system 24 at the second ends 206 of the support linkage elements 202. Each of the support linkage elements 202 are in-line with one of the first elongated linkage elements 110, one of the second elongated linkage elements 160 and/or one of the actuator cylinders 180. The support linkage elements 202 being in-line with the first elongated linkage elements 110, the second elongated linkage elements 160 and/or the actuator cylinders 180 may reduce horizontal loading in the counterweight assembly 18 compared to if the support linkage elements 202 were not in-line with the first elongated linkage elements 110, the second elongated linkage elements 160 and/or the actuator cylinders 180. In other examples, the winch support 200 includes a single support linkage element 202.

The support linkage elements 202 each define a lower support linkage aperture 208 extending through the support linkage elements 202 proximate the first ends 204 of the support linkage elements 202 and an upper support linkage aperture 210 extending through the support linkage elements 202 proximate the second ends 206 of the support linkage elements 202. Each of the support linkage elements 202 are pivotally coupled to one of the machine mounting brackets 100 by a fifth fastener 212 extending through the lower support linkage aperture 208 of the support linkage element 202 and the upper machine mounting bracket aperture 104 of the machine mounting bracket 100. Each of the support linkage elements 202 are configured to be pivotally coupled to the chassis 12 and/or the winch system 24 by a fastener extending through the upper support linkage aperture 210 of the support linkage element 202 and an aperture of the chassis 12 and/or the winch system 24.

In some examples, the winch support 200 includes a second cross plate 214 coupled between the support linkage elements 202. For example, the second cross plate 214 may extend between the support linkage elements 202 to ensure that the support linkage elements 202 pivot together relative to the machine mounting brackets 100 and/or to transfer loading between the support linkage elements 202.

As shown in FIG. 4, a first of the bracket plates 132 of one of the plate mounting brackets 130 defines a first plane P₁. The first plane P₁ extends along the first of the bracket plates 132. For example, the first plane P₁ may extend parallel to the first of the bracket plates 132. In some examples, an inside surface of the first of the bracket plates 132 defines the first plane P₁. The first plane P₁ may extend substantially perpendicular (e.g., transverse) to the machine axis of the lifting machine 10. For example, the first plane P₁ may be a transverse plane to the machine axis of the lifting machine 10.

As shown in FIG. 4, a second of the bracket plates 132 of the same plate mounting bracket 130 defines a second plane P₂. The second plane P₂ extends along the second of the bracket plates 132. For example, the second plane P₂ may extend parallel to the second of the bracket plates 132. The second plane P₂ is substantially parallel to the first plane P₁. In some examples, an inside surface of the second of the bracket plates 132 defines the second plane P₂. The second plane P₂ may extend substantially perpendicular to the machine axis of the lifting machine 10. At least one of the first elongated linkage elements 110, the second elongated linkage elements 160, the actuator cylinders 180, or the support linkage elements 202 may be positioned between the first plane P₁ and the second plane P₂. In some examples, one of the first elongated linkage elements 110, one of the second elongated linkage elements 160, one of the actuator cylinders 180, and one of the support linkage elements 202 are positioned between the first plane P₁ and the second plane P₂.

As shown in FIG. 4, a third plane P₃ is positioned between the first plane P₁ and the second plane P₂. The third plane P₃ (e.g., a transverse plane to the machine axis of the lifting machine 10) is substantially parallel to the first plane P₁ and the second plane P₂. At least one of the first elongated linkage elements 110, the second elongated linkage elements 160, the actuator cylinders 180, or the support linkage elements 202 are in-line within the third plane P₃. In some examples, one of the first elongated linkage elements 110, one of the second elongated linkage elements 160, one of the actuator cylinders 180, and one of the support linkage elements 202 are in-line within the third plane P₃. For example, when the plate mounting bracket 130 to one side of the weights 154 defines the first plane P₁ and the second plane P₂, the corresponding first elongated linkage element 110, second elongated linkage element 160, actuator cylinder 180, and support linkage element 202 on that same side may be in-line within the third plane P₃. The third plane P₃ may extend substantially perpendicular to the machine axis of the lifting machine 10.

As shown in FIG. 4, the pair of the bracket plates 132 of one of the plate mounting brackets 130 define a linkage region A_{L} positioned between the pair of the bracket plates 132. For example, the linkage region A_{L} may be positioned between a portion of the first plane P₁ extending along the first of the bracket plates 132 and a portion of the second plane P₂ extending along the second of the bracket plates 132. The first elongated linkage element 110 and the second elongated linkage element 160 coupled to the plate mounting bracket 130 are coupled to the plate mounting bracket 130 within the linkage region A_{L}. For example, the first elongated linkage elements 110 and the second elongated linkage elements 160 may be pivotably coupled to the plate mounting brackets 130 in a region located between the bracket plates 132 of the plate mounting brackets 130. In some examples, one of the actuator cylinders 180 is coupled to one of the second elongated linkage elements 160 in alignment with the linkage region A_{L}.

As shown in FIG. 5, the machine mounting brackets 100 are arranged on first axes A_{MMB} (only one axis A_{MMB} shown in FIG. 5). The first axes A_{MMB} are substantially vertical. For example, the first axes A_{MMB} may be substantially perpendicular to the machine axis of the lifting machine 10. In some examples, one of the first axes A_{MMB} is positioned on the third plane P₃ such that it partially defines the third plane P₃.

Extension of the actuator cylinders 180 causes the first elongated linkage elements 110 and the second elongated linkage elements 160 to swing away from the first axes A_{MMB} in a direction D₁ such that the counterweight assembly 18 moves from the retracted configuration towards the extended configuration. For example, the direction D₁ may be along a path followed by a center of gravity of the counterweight assembly 18 as the counterweight assembly 18 moves from the retracted configuration towards the extended configuration. The third plane P₃ may be collectively defined by one of the first axes A_{MMB} and the direction D₁.

As shown in FIG. 5, when the counterweight assembly 18 is in the retracted configuration, there is a first vertical distance VD₁ from the second connection point between the first elongated linkage elements 110 and the plate mounting brackets 130 to the fourth connection point between the second elongated linkage elements 160 and the plate mounting brackets 130. For example, the first vertical distance VD₁ may be between the second fasteners 138 pivotally coupling the first elongated linkage elements 110 and the plate mounting brackets 130 and the third fasteners 170 pivotally coupling the second elongated linkage elements 160 and the plate mounting brackets 130. In some examples, the first vertical distance VD₁ is between 360 millimeters (mm) and 380 mm. In other examples, the first vertical distance VD₁ is between 370 mm and 450 mm. In still other examples, the first vertical distance VD₁ is between 250 mm and 350 mm.

As shown in FIG. 5, when the counterweight assembly 18 is in the retracted configuration, there is a second vertical distance VD₂ from the second connection point between the first elongated linkage elements 110 and the plate mounting brackets 130 to the first connection point between the first elongated linkage elements 110 and the machine mounting brackets 100. For example, the second vertical distance VD₂ may be between the second fasteners 138 pivotally coupling the first elongated linkage elements 110 and the plate mounting brackets 130 and the first fasteners 120 pivotally coupling the first elongated linkage elements 110 and the machine mounting brackets 100. In some examples, the second vertical distance VD₂ is between 1855 mm and 1875 mm. In other examples, the second vertical distance VD₂ is between 1785 mm and 1865 mm. In still other examples, the second vertical distance VD₂ is between 1885 mm and 1965 mm.

In some examples, a first ratio of the first vertical distance VD₁ to the second vertical distance VD₂ is greater than 5%. In some examples, the first ratio of the first vertical distance VD₁ to the second vertical distance VD₂ is greater than 15%. In other examples, the first ratio of the first vertical distance VD₁ to the second vertical distance VD₂ is less than or equal to 5% (e.g., between 0% and 5%). This first ratio facilitates the nesting of the first elongated linkage elements 110 with the second elongated linkage elements 160, described herein, that allows the in-line configuration of a first elongated linkage element 110 and a second elongated linkage element 160.

As shown in FIG. 5, when the counterweight assembly 18 is in the retracted configuration, there is a first horizontal distance HD₁ from the second connection point between the first elongated linkage elements 110 and the plate mounting brackets 130 to the fourth connection point between the second elongated linkage elements 160 and the plate mounting brackets 130. For example, the first horizontal distance HD₁ may be between the second fasteners 138 pivotally coupling the first elongated linkage elements 110 and the plate mounting brackets 130 and the third fasteners 170 pivotally coupling the second elongated linkage elements 160 and the plate mounting brackets 130. In some examples, the first horizontal distance HD₁ is between 4 mm and 7 mm. In other examples, the first horizontal distance HD₁ is between 5 mm and 15 mm.

In some examples, a second ratio of the first horizontal distance HD₁ to the first vertical distance VD₁ is less than 2%. In other examples, the second ratio of the first horizontal distance HD₁ to the first vertical distance VD₁ is less than 5%. In some examples, a third ratio of the first horizontal distance HD₁ to the second vertical distance VD₂ is less than 0.5%. In other examples, the third ratio of the first horizontal distance HD₁ to the second vertical distance VD₂ is less than 3%. These ratios provide compactness to the counterweight assembly 18, allowing for a center of gravity of the counterweight assembly 18 in the retracted configuration to be held close to the machine 10, thereby improving a stability and a mobility of the machine 10.

As shown in FIG. 5, when the counterweight assembly 18 is in the retracted configuration, there is a second horizontal distance HD₂ from the second connection point between the first elongated linkage elements 110 and the plate mounting brackets 130 to the first connection point between the first elongated linkage elements 110 and the machine mounting brackets 100. For example, the second horizontal distance HD₂ may be between the second fasteners 138 pivotally coupling the first elongated linkage elements 110 and the plate mounting brackets 130 and the first fasteners 120 pivotally coupling the first elongated linkage elements 110 and the machine mounting brackets 100. In some examples, the second horizontal distance HD₂ is between 120 mm and 130 mm. In some examples, a fourth ratio of the second horizontal distance HD₂ to the first vertical distance VD₁ is less than 40%. In some examples, a fifth ratio of the second horizontal distance HD₂ to the second vertical distance VD₂ is less than 8%. In some examples, a sixth ratio of the first horizontal distance HD₁ to the second horizontal distance HD₂ is less than 6%. In other embodiments, the sixth ratio of the first horizontal distance HD₁ to the second horizontal distance HD₂ is less than 30%. These ratios also provide compactness to the counterweight assembly 18, as described herein.

As indicated above, FIGS. 2-5 are provided as an example. Other examples may differ from what is described in connection with FIGS. 2-5.

### INDUSTRIAL APPLICABILITY

The counterweight assembly 18 described herein may be used with any lifting machine 10 that performs a lifting operation associated with an industry such as, for example, mining, construction, farming, transportation, or another industry. For example, the counterweight assembly 18 may be included on a pipelayer machine used to lift and place pipes in connection with construction operations or oil and gas recovery operations. The counterweight assembly 18 can counteract the weight being lifted by the lifting machine 10 to provide balance, stability, and enhanced lifting capacity. Due to the immense amount of counterweight involved, a counterweight assembly may generally include a complex system of linkages and actuators that are difficult to machine, assemble, and install on a machine.

The counterweight assembly 18 described herein provides a system of linkages and actuators that is simple, yet capable of supporting and extending a large amount of counterweight. In particular, the in-line configuration of the counterweight assembly 18 facilitates the use of simpler and fewer parts that can be machined, assembled, and installed on the lifting machine 10 faster and with less difficulty. Accordingly, the in-line configuration of the counterweight assembly 18 also improves servicing, repair, and replacement of the counterweight assembly 18. Furthermore, the in-line configuration of the counterweight assembly 18 reduces bulkiness and maintains a center of gravity of the counterweights near to the lifting machine 10 when the counterweight assembly 18 is retracted, thereby enhancing a compactness, mobility, and stability of the lifting machine 10. In addition, the in-line configuration of the counterweight assembly 18 allows for counterweight to be centered on the counterweight assembly 18, thereby reducing stress on the counterweight assembly 18 and improving balance.

The foregoing describes only some embodiments, and alterations, modifications, additions and/or changes can be made thereto without departing from the scope and spirit of the disclosed embodiments, the embodiments being illustrative and not restrictive. Furthermore, implementations are not limited to the disclosed embodiments, and may cover various modifications and equivalent arrangements included within the spirit and scope of the disclosed embodiments. Also, the various embodiments described above may be implemented in conjunction with other embodiments, for example, aspects of one embodiment may be combined with aspects of another embodiment to realize yet other embodiments. Further, each independent feature or component of any given assembly or process may constitute an additional embodiment. As used herein, the singular forms of “a,” “an,” and “the” include plural referents unless the context clearly dictates otherwise. In addition, as used herein, the term “or” means “and/or” unless the context clearly dictates otherwise.

Further, spatially relative terms, such as “vertical,” “horizontal,” “above,” “below,” etc., may be used herein to describe one element or feature’s relationship to another element(s) or feature(s) as illustrated in the figures. The spatially relative terms are intended to encompass different orientations in use or operation in addition to the orientation(s) depicted in the figures. Accordingly, the spatially relative terms may be interpreted in a corresponding manner to rotations of the orientation(s) depicted in the figures.

What is claimed is:

1. A counterweight assembly, comprising:
a machine mounting bracket arranged on an axis that is substantially vertical;
a first elongated linkage element pivotally coupled to the machine mounting bracket at a first end of the first elongated linkage element and pivotally coupled to a plate mounting bracket at a second end of the first elongated linkage element;
a second elongated linkage element pivotally coupled to the plate mounting bracket at an end of the second elongated linkage element; and
an actuator cylinder coupled to the second elongated linkage element,
wherein extension of the actuator cylinder is to cause the first elongated linkage element and the second elongated linkage element to swing away from the axis in a direction, and
wherein the first elongated linkage element, the second elongated linkage element, and the actuator cylinder are in-line within a plane defined by the axis and the direction.

2. The counterweight assembly of claim 1, wherein a first connection point of the first elongated linkage element to the plate mounting bracket is nearer to the machine mounting bracket than a second connection point of the second elongated linkage element to the plate mounting bracket.

3. The counterweight assembly of claim 1, wherein the plate mounting bracket comprises a pair of opposing bracket plates that define a linkage region between the pair of opposing bracket plates, and
wherein the first elongated linkage element and the second elongated linkage element are coupled to the plate mounting bracket within the linkage region.

4. The counterweight assembly of claim 1, wherein the first elongated linkage element has a bent section configured to nest within a corresponding bent section of the second elongated linkage element in a retracted configuration of the counterweight assembly.

5. The counterweight assembly of claim 1, wherein in a retracted configuration of the counterweight assembly, a first vertical distance is from a first connection point of the first elongated linkage element to the plate mounting bracket to a second connection point of the second elongated linkage element to the plate mounting bracket, and a second vertical distance is from the first connection point of the first elongated linkage element to the plate mounting bracket to a third connection point of the first elongated linkage element to the machine mounting bracket, and
wherein a ratio of the first vertical distance to the second vertical distance is greater than 15%.

6. The counterweight assembly of claim 1, wherein in a retracted configuration of the counterweight assembly, a vertical distance is from a first connection point of the first elongated linkage element to the plate mounting bracket to a second connection point of the second elongated linkage element to the plate mounting bracket, and a horizontal distance is from the first connection point to the second connection point, and
wherein a ratio of the horizontal distance to the vertical distance is less than 2%.

7. The counterweight assembly of claim 1, further comprising:
a winch support comprising a support linkage element pivotally coupled to the machine mounting bracket,
wherein the support linkage element is in-line with the plane.

8. The counterweight assembly of claim 7, wherein a first connection point of the support linkage element to the machine mounting bracket is nearer to the second elongated linkage element than a second connection point of the first elongated linkage element to the machine mounting bracket.

9. The counterweight assembly of claim 1, further comprising:
a weight assembly comprising a carrying plate connected to the plate mounting bracket and one or more weights connected to the carrying plate.

10. The counterweight assembly of claim 9, further comprising:
an additional plate mounting bracket connected to the carrying plate,
wherein the one or more weights are connected to the carrying plate between the plate mounting bracket and the additional plate mounting bracket.

11. A counterweight assembly, comprising:
a weight assembly comprising a carrying plate configured to carry one or more weights;
a plate mounting bracket, connected to the carrying plate, comprising a pair of opposing bracket plates that define a linkage region between the pair of opposing bracket plates;
a machine mounting bracket;
a first elongated linkage element pivotally coupled to the machine mounting bracket and pivotally coupled to the plate mounting bracket within the linkage region;
a second elongated linkage element pivotally coupled to the plate mounting bracket within the linkage region; and
an actuator cylinder coupled to the second elongated linkage element in alignment with the linkage region.

12. The counterweight assembly of claim 11, wherein the first elongated linkage element, the second elongated linkage element, and the actuator cylinder are in-line.

13. The counterweight assembly of claim 11, wherein a first connection point of the first elongated linkage element to the plate mounting bracket is nearer to the machine mounting bracket than a second connection point of the second elongated linkage element to the plate mounting bracket.

14. The counterweight assembly of claim 11, wherein the first elongated linkage element has a bent section configured to nest within a corresponding bent section of the second elongated linkage element in a retracted configuration of the counterweight assembly.

15. The counterweight assembly of claim 11, wherein in a retracted configuration of the counterweight assembly, a vertical distance is from a first connection point of the first elongated linkage element to the plate mounting bracket to a second connection point of the second elongated linkage element to the plate mounting bracket, and a horizontal distance is from the first connection point to the second connection point, and
wherein a ratio of the horizontal distance to the vertical distance is less than 1.75%.

16. A lifting machine, comprising:
a chassis having a front end and a rear end defining a machine axis;
a crane assembly mounted on the chassis; and
a counterweight assembly, comprising:
a machine mounting bracket mounted on the chassis;
a first elongated linkage element pivotally coupled to the machine mounting bracket at a first end of the first elongated linkage element and pivotally coupled to a plate mounting bracket at a second end of the first elongated linkage element;
a second elongated linkage element pivotally coupled to the plate mounting bracket at an end of the second elongated linkage element; and
an actuator cylinder coupled to the second elongated linkage element,
wherein the first elongated linkage element, the second elongated linkage element, and the actuator cylinder are in-line within a transverse plane to the machine axis.

17. The lifting machine of claim 16, wherein the lifting machine is a pipelayer machine.

18. The lifting machine of claim 16, wherein a first connection point of the first elongated linkage element to the plate mounting bracket is nearer to the machine mounting bracket than a second connection point of the second elongated linkage element to the plate mounting bracket.

19. The lifting machine of claim 16, further comprising:
a weight assembly comprising a carrying plate connected to the plate mounting bracket and one or more weights connected to the carrying plate.

20. The lifting machine of claim 19, further comprising:
an additional plate mounting bracket connected to the carrying plate,
wherein the one or more weights are connected to the carrying plate between the plate mounting bracket and the additional plate mounting bracket.
